(19) United States
(12) Patent Application Publication
(10) Pub. No.: US 2011/0271186 A1
(43) Pub. Date: Nov. 3, 2011

(54) Visual audio mixing system and method thereof

(76) Inventor: John Colin Owens, Jamaica Plain, MA (US)

(21) Appl. No.: 12/799,716

(22) Filed: Apr. 30, 2010

(51) Int. Cl. G06F 3/01

(52) U.S. Cl. 715/716

(57) ABSTRACT

A visual audio mixing system which includes an audio input engine configured to input one or more audio files each associated with a channel. A shape engine is responsive to the audio input engine and is configured to create a unique visual image of a definable shape and/or color for each of the one or more of audio files. A visual display engine is responsive to the shape engine and is configured to display each visual image. A shape select engine is responsive to the visual display engine and is configured to provide selection of one or more visual images. The system includes a two-dimensional workspace. A coordinate engine is responsive to the shape select engine and is configured to instantiate selected visual images in the two-dimensional workspace. A mix engine is responsive to coordinate engine and is configured to mix the visual images instantiated in the two-dimensional workspace such that user provided movement of one or more of the visual images in one direction represents volume and user provided movement in another direction represents pan to provide a visual and audio representation of each audio file and its associated channel.

### FIELD OF THE INVENTION

This invention relates to a visual audio mixing system and method thereof.

### BACKGROUND OF THE INVENTION

Audio mixing is the process by which a multitude of recorded sounds are combined into one or more channels. At a basic level, audio mixing may be considered the act of placing recorded sound in position according to distance (volume) and orientation (pan) in a multi-speaker environment. The goal of audio mixing is to create a recording that sounds as natural as a live performance, incorporate artistic effects, and correct errors.

Conventional analog audio mixing consoles, or decks, combine input audio signals from multiple channels using controls for panning and volume. The mixing deck typically includes a slider for each channel which controls the volume. The volume refers to a perceived loudness, typically measured in Db. The mixing deck also includes a potentiometer knob located at the top of each slider which pans the audio to the left or right. To achieve a desired audio effect of sound relative to position, the volume is increased or decreased (which translates to front and back positions) and the audio may be paned left or right.

Conventional computer systems are known which utilize a visual mirror of an analog mixing deck. Typically, all of the controls on the virtual mixing deck are visually identical to the conventional mixing deck. However, audio mixing using a virtual mixing deck does not provide visual feedback as to the position of the audio for each of channels with respect to each other in a multi-speaker environment. Therefore, skilled audio engineers are typically needed to properly mix the audio.

One conventional system for mixing sound using visual images is disclosed in U.S. Pat. No. 6,898,291 (the '291 patent), incorporated by reference herein. As disclosed therein, audio signals are transformed into a three-dimensional image which is placed in a three-dimensional workspace. In one example, positioning the image in a first dimension (x-axis) correlates to pan control, positioning the image in a second dimension (y-axis) correlates to frequency, and positioning the image in third dimension (z-axis) correlates volume.

However, the three-dimensional system as disclosed in the '291 patent is cumbersome and difficult to use. For example, objects may obscure other objects in the three-dimensional workspace making them difficult to select and move visually without some kind of supplementary window that isolates the individual sound objects. Additionally, the '291 patent discloses a visual image of a sound should never appear further from the left than the left speaker or further right than the right speaker. Therefore, the '291 patent uses either the left or right speaker or the left and right wall to limit the travel of the visual images. The limits of the '291 patent bounding two-dimensional wall system for pan space in the use of a three-dimensional room metaphor precludes the '291 patent for use as a multi-channel system. Further, the metaphor of the '291 patent breaks down once three or more visual speakers are placed into the environment. For example, if a set of rear channels were placed into the environment, it would be unclear where they would be placed. Additionally, if the visual speakers were placed within the existing metaphor, they would either have to be displayed within the existing front view. This does not make sense because the three-dimensional metaphor of the '291 patent would dictate that the speakers would have to be placed behind the mixer and thus off the screen. Additionally, if the visual speakers were placed within the existing metaphor, the three-dimensional navigation system on the two-dimensional screen would have to be used in order to solve the problem. This would make use of the system as disclosed in the '291 patent difficult because at times much of the environment would be invisible to the user.

Additionally, the '291 patent relies on the Y-axis, or vertical pan, to represent the sounds placed in a frequency range. Thus, the Y location of the sphere as disclosed by the '291 patent is correlated to frequency. One problem with representing objects as frequency on any plane relative to another is that each sound source must be analyzed to determine where the objects position will be. Any sound may occupy the same frequency domain at the same time and obscure the representation of another object. Additionally, there exists a possibility that two or more sources can occupy the entire frequency spectrum or similar places in the frequency spectrum. Thus, it would be unclear where one source would begin and another would end.

### BRIEF SUMMARY OF THE INVENTION

This invention features a visual audio mixing system which includes an audio input engine configured to input one or more audio files each associated with a channel. A shape engine is responsive to the audio input engine and is configured to create a unique visual image of a definable shape and/or color for each of the one or more of audio files. A visual display engine is responsive to the shape engine and is configured to display each visual image. A shape select engine is responsive to the visual display engine and is configured to provide selection of one or more visual images. The system includes a two-dimensional workspace. A coordinate engine is responsive to the shape select engine and is configured to instantiate selected visual images in the two-dimensional workspace. A mix engine is responsive to coordinate engine and is configured to mix the visual images instantiated in the two-dimensional workspace such that user provided movement of one or more of the visual images in one direction represents volume and user provided movement in another direction represents pan to provide a visual and audio representation of each audio file and its associated channel.

In one embodiment, system may include an audio output engine configured to output one or more audio files including the audio representation of the mix. The audio output engine may be configured to output one or more composite files including the visual and audio representation of the mix. The input audio files and/or the output audio files and/or the output composite files may be stored in a marketplace. The marketplace may provide for exchanging of the input audio files and/or the output audio files and/or the output composite files by a plurality of users. The input audio engine may be configured to input the input audio files and/or the output audio files and/or the composite files from the marketplace. The coordinate engine may be responsive to an input device. The input device may include one or more of: a mouse, a touch screen, and/or tilting of an accelerometer. The input device may be configured to position the visual images instantiated in the two-dimensional workspace to adjust the volume and pan of the visual images in the two-dimensional workspace to create and/or modify the visual and audio representation of each audio file and its associated channel. User defined movement of one of the visual images instantiated in the two-dimensional workspace by the input device in a vertical direction may adjust the volume associated with the visual image and user defined movement of the visual image by the input device in a horizontal direction adjusts the pan associated with the visual image. The physics engine may be responsive to the coordinate engine and may be configured to simulate behavior of the one or more visual images instantiated in the two-dimensional workspace. The physics engine may include a collision detect engine configured to prevent two or more visual images instantiated in the two-dimensional workspace from occupying the same position at the same time. The collision detect engine may be configured to cause the two or more visual images instantiated in the two-dimensional workspace which attempted to occupy the same location at the same time to repel each other. The physics engine may be configured to define four walls in the two-dimensional workspace. The physics engine may include a movement engine responsive to user defined movement of the input device in one or more predetermined directions. The movement engine may be configured to cause selected visual images instantiated in the two-dimensional workspace to bounce off one or more of the four walls. The bouncing of the one or more visual images off one or more of the four walls may cause the sounds associated with the selected visual images to shift slightly over time. The physics engine may include an acceleration level engine responsive to user defined movement of the input device in one or more predetermined directions configured to cause visual images instantiated in the two-dimensional workspace to be attracted to one or more of the four walls to simulate gravity. The shape select engine may be configured to add a desired effect to the visual images instantiated in the two-dimensional workspace. The shape select engine may be configured to change the appearance of one or more visual images instantiated in the two-dimensional workspace based on the desired effect. The desired effect may include one or more of reverberation, delay and/or a low pass filter. The change of appearance of the one or more visual images may be instantiated in the two-dimensional workspace includes softening of the visual image to represent the desired effect. The change of appearance of the one or more visual images instantiated in the two-dimensional workspace may include moving concentric rings to represent the desired effect. The change of appearance of the one or more visual images instantiated in the two-dimensional workspace may include shading of the one or more selected visual images. The shape select engine may be configured to mute all but one visual image instantiated in the two-dimensional workspace.

This invention features a visual audio mixing system including an audio input engine configured to input one or more audio files each associated with a channel. A shape engine is responsive to the audio input engine and is configured to create a unique visual image of a definable shape and/or color for each of the one or more of audio files. The system includes a two-dimensional workspace. A coordinate engine is responsive to the shape select engine and is configured to instantiate selected visual images in the two-dimensional workspace. A mix engine is responsive to coordinate engine and is configured to mix the visual images instantiated in the two-dimensional workspace such that user provided movement of one or more of the visual images in one direction represents volume and user provided movement in another direction represents pan to provide a visual and audio representation of each audio file and its associated channel.

This invention further features a method of visual audio mixing, the method including inputting one or more audio files each associated with a channel, creating a unique visual image of a definable shape and/or color for each of the one or more of audio file, displaying each visual image, selecting of one or more visual images, instantiating selected visual images in a two-dimensional workspace, and mixing the visual images instantiated in the two-dimensional workspace such that user provided movement of one or more of the visual images in one direction represents volume and user provided movement in another direction represents pan to provide a visual and audio representation of each audio file and its associated channel.

This invention also features a method of visual audio mixing, the method including inputting one or more audio files each associated with a channel, creating a unique visual image of a definable shape and/or color for each of the one or more of audio file, instantiating selected visual images in a two-dimensional workspace, and mixing the visual images instantiated in the two-dimensional workspace such that user provided movement of one or more of the visual images in one direction represents volume and user provided movement in another direction represents pan to provide a visual and audio representation of each audio file and its associated channel.

The subject invention, however, in other embodiments, need not achieve all these objectives and the claims hereof should not be limited to structures or methods capable of achieving these objectives.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram showing the primary components of one embodiment of the audio-visual mixing system and method of this invention;

FIG. 2 is a view of a screen showing one example of the selection of a plurality of audio files each associated with a channel track of an artist's song and further showing examples of unique visual images associated with each of the selected audio files;

FIG. 3 shows examples of additional visual images which may be created by the shape engine shown in FIG. 1;

FIG. 4 is a view of a screen showing an example of a user selecting a visual image and placing it into the work area shown in FIG. 2;

FIG. 5 is a view of a screen showing one example of visual images instantiated in the two-dimensional workspace wherein a user has positioned the visual images in the two-dimensional workspace to provide visual and audio representation of each of the selected audio files shown in FIG. 4;

FIG. 6 is a view of a screen showing an example of a sound represented by a visual image positioned in the middle of the two-dimensional workspace to set the volume at half and the pan position in the middle;

FIG. 7 is a view of a screen showing an example of a sound represented by a visual image positioned in the middle and far right of the two-dimensional workspace to set the volume at half and the pan position to the right;

FIG. 8 is a view of screen showing an example of a sound represented by a visual image positioned in the middle and to the far left of the two-dimensional workspace to set the volume at half and the pan position to the left;

FIG. 9 is a view of a screen showing an example of a sound represented by a visual image positioned in the middle and top of the two-dimensional workspace to set the volume at full and the pan position in the middle;

FIG. 10 is a view of a screen showing an example of a sound represented by a visual image positioned in the middle and bottom of the two-dimensional workspace to set the volume at zero and the pan position in the middle;

FIG. 11 is a view of a screen shown in FIG. 5 depicting one example of a user saving the mix in the two-dimensional workspace;

FIG. 12 is a view of the screen showing in further detail the process of saving a mix as on output file;

FIG. 13 is a view of a screen showing one example of a user attempting to position two visual images in the two-dimensional workspace at the same position and at the same time;

FIGS. 14 and 15 are views showing the two visual images shown in FIG. 13 repelling from each other;

FIG. 16 is a view of a screen showing one example of visual images instantiated in the two-dimensional workspace bouncing off one of the walls to simulate the sounds of each visual image representing a channel shifting slightly over time;

FIGS. 17 and 18 are view showing in further detail the visual images bouncing off the wall shown in FIG. 16;

FIGS. 19-21 are views showing an example of visual images instantiated in the two-dimensional workspace simulating the effect of gravity;

FIG. 22 is a view of a screen showing one example of an effects window used to add a desired effect to one or more of the visual images instantiated in the two-dimensional workspace;

FIGS. 23-24 are views showing one example of a delayed effect created on a visual image in the two-dimensional workspace;

FIGS. 25-27 are views showing one example of a reverberation effect created on a visual image in the two-dimensional workspace;

FIGS. 28-30 are views showing one example of a low pass filter effect created on a visual image in the two-dimensional workspace;

FIGS. 31-32 are views showing one example of the selection one visual image in the two-dimensional workspace and muting all the other visual images; and

FIG. 33 is a view of a screen showing one example of a user manipulating a visual image's position according to time.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

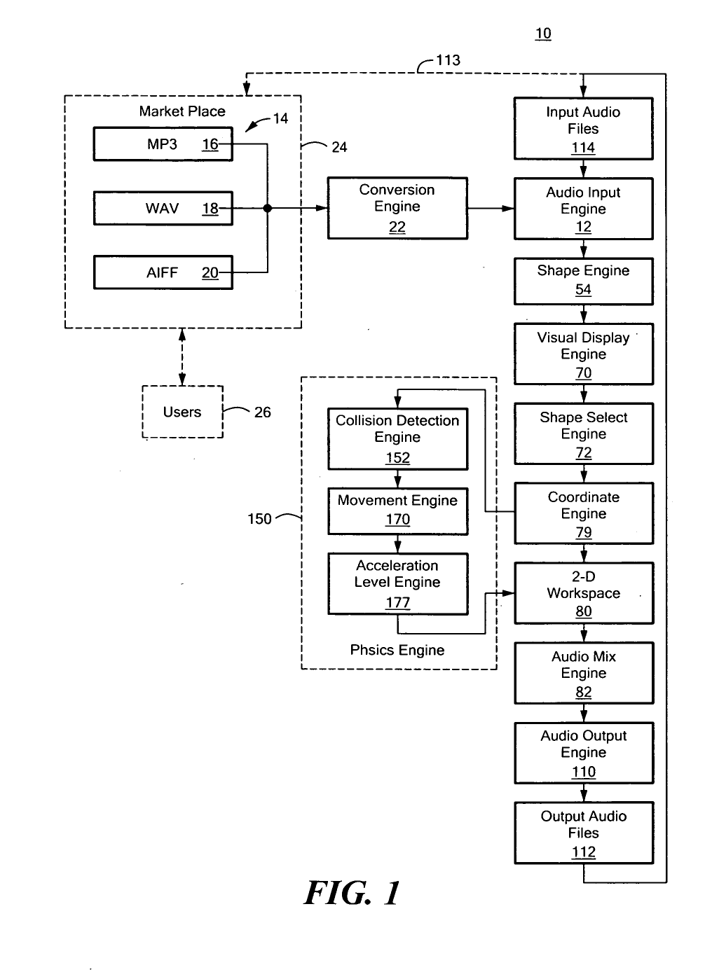

There is shown in FIG. 1 one embodiment of visual audio mixing system 10 of this invention. Visual audio mixing system 10 includes audio input engine 12 configured to input one or more audio files 14 each associated with a channel. In one example, audio files 14 may include MP₃ files 14, wave audio format (WAV) files 18, Audio Interchange File Format (AIFF) files 20, or any similar type audio file known to those skilled in the art. System 10 also preferably includes conversion engine 22 which converts audio files 14 to a desired format for audio input engine 12 e.g., a linear pulse code modulation (LPCM), MP₃ or similar type format. In one embodiment, audio input engine 12 is configured to input audio files 14 from marketplace 24. Marketplace 24 preferably provides for exchanging input audio files by a plurality of users 26 (discussed in further detail below). In one example, the exchange of audio files 14 by users 26 may be via the interne or similar type exchange platforms.

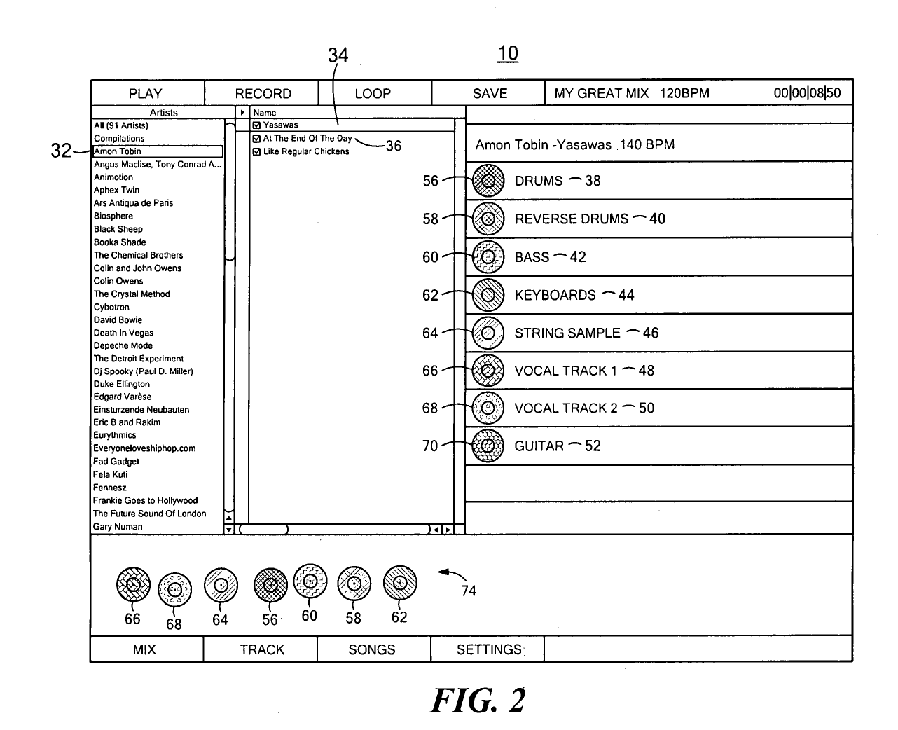

FIG. 2 shows one example of screen 30 generated by system 10 wherein a user has selected particular audio files associated with particular channels for a desired artist from marketplace 24. In this example, the user has selected the user the artist Amon Tobin, indicated at 32, the album Yasawas, indicated at 34, the song “At the end of the day”, indicated at 36. The user has then selected the audio file for drums on channel 0, indicated at 38, the audio file for reverse drums on channel 1, indicated at 40, the audio file for bass on channel 2, indicated at 42, the audio file for keyboards on channel 3, indicated at 44, the audio file for string sample on track 4, indicated at 46, the audio file for vocal track 1 on channel 5, indicated at 48, the audio file for vocal track 2 on channel 6, indicated at 50, and the audio file for guitar on track 7, indicated at 52.

Shape engine 54, FIG. 1, is responsive to audio input engine 12 and is configured to create a unique visual image of a definable shape and/or color for each of the input audio files associated with a channel selected by a user. In this example, shape engine 54 creates visual image 56 having a circular shape and blue color to represent the drum audio file on track 0. Similarly, in this example, shape engine 54 creates visual image 58 having a circular shape and green color to represent the reverse drums audio file on track 1, visual image 60 having a circular shape and pink color to represent the base audio file on track 2, and visual image 62 having a circular shape and dark blue color to represent the keyboards audio file on track 3, visual image 64 having a circular shape and brownish color to represent the string sample audio file on track 4, visual image 66 having a circular shape and purple color to represent the voice track 1 audio file on track 5, visual image 68 having a circular shape and dark pink color to represent the voice track 2 audio file on track 6, visual image 70 having a circular shape and green color to represent the drum audio file on track 7.

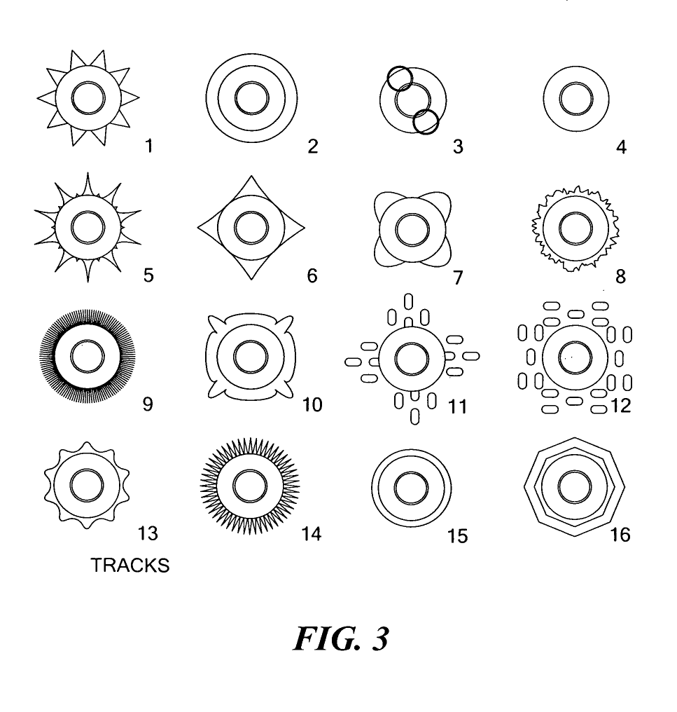

In other examples, the visual images created by shape engine 54 may have different shapes, shading, contrasts, colors, and the like. FIG. 3 shows one example of the other various shapes for the visual images which may be created by shape engine 50, FIG. 1. The colors of the shapes of the various visual images shown in FIG. 3 may be any number of colors, as known by those skilled in the art.

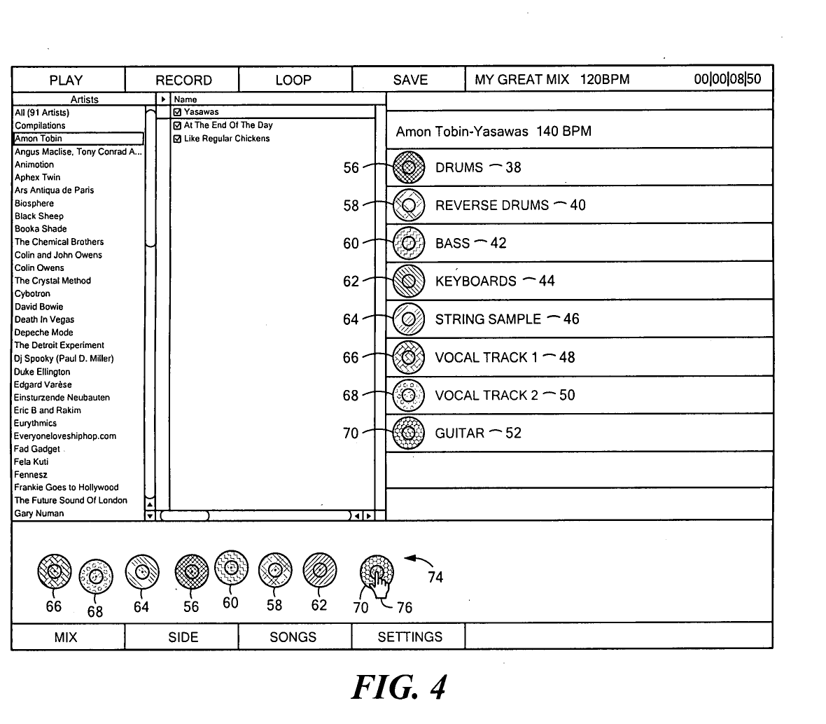

Visual display engine 70, FIG. 1, is responsive to shape engine 50 and is configured to display each visual image created by shape engine 54 on selection area 55 of screen 30, FIG. 2. Shape select engine 72, FIG. 1, is responsive to visual display engine 70 and allows a user to select one or more the visual images in area 55 to be mixed. To do this, the user clicks on the desired visual image and drags it to work area 74, FIG. 2. In this example, a user has previously moved visual images 56-68 work area 74 and wants to move visual image 70 for the guitar audio file on track 7 to work area 74. As shown at 76, FIG. 4, the user has clicked on visual image 70 and moved it to work area 74.

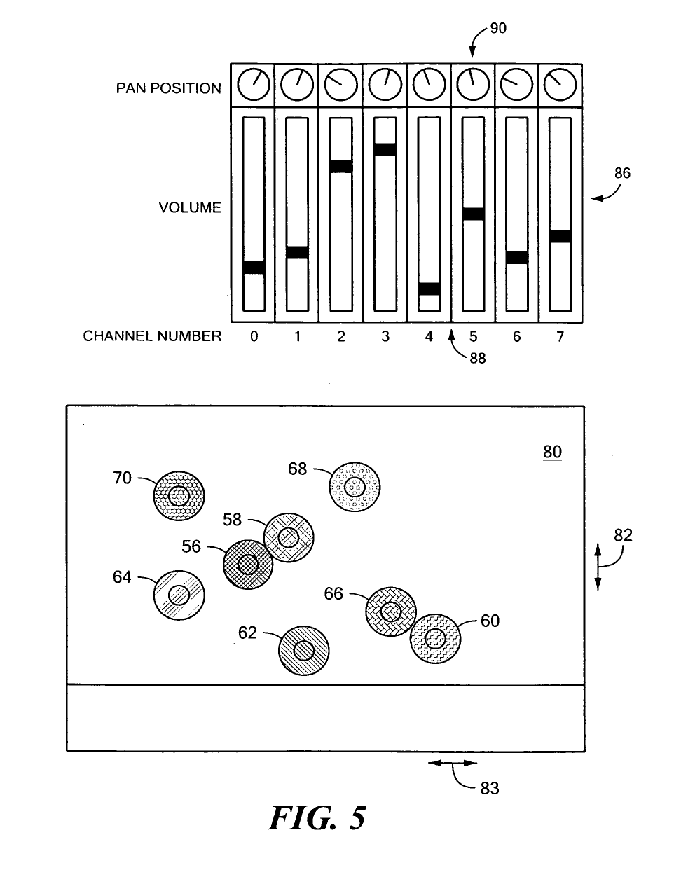

To mix visual images 56-70 in work area 74, the user hits mix control button 78. This causes coordinate engine 79, FIG. 1, to instantiate the visual images 56-70, FIG. 4, in work area 74 into two-dimensional workspace 80, FIGS. 1 and 5. As shown in FIG. 5, coordinate engine 79 has instantiated visual images 56-70 into two-dimensional workspace 80.

Audio mix engine 82, FIG. 1, is responsive to coordinate engine 76 and is configured to mix the selected visual images instantiated in two-dimensional workspace 80, FIG. 5, such that user provided movement of visual images instantiated in two-dimensional workspace 80 in one direction represents the volume and user provided movement in another direction represents the pan to provide a visual and audio representation of each of the input audio files and its associated channel. In one design, movement of the visual images in a vertical direction, indicated by arrow 82, may be used to adjust the volume of the audio associated with the visual images instantiated in two-dimensional workspace 80 and movement of the visual images in the horizontal direction, indicated by arrow 83 may be used to adjust the pan associated with the visual images instantiated in two-dimensional workspace 80. However, this is not a necessary limitation of this invention, as the visual images may be moved in different directions and on different axes to adjust the volume and pan.

In the example shown in FIG. 5, the user has positioned visual images 56-70 in two-dimensional workspace 80 to provide a visual and audio representation of a mix which corresponds to the same mix as shown by conventional mixing deck 86. Conventional mixing deck 86 typically includes sliders 88 which adjust the volume for channels 0-7 and potentiometers 90 which adjust the pan positions for channels 0-7.

Coordinate engine 79, FIG. 1, is responsive to an input device, e.g., a mouse, a touch screen, or tilting of an accelerometer, e.g., the tiling of an iPhone®, iPad®, or similar type device. In order to position the visual images in two-dimensional workspace 80, the user clicks on the desired visual image with a mouse and drags the visual image to the desired locations in the two-dimensional workspace to adjust the volume and pan. The process is repeated for each visual image instantiated in the two-dimensional workspace. In other examples, the input device may be a touch screen and the user may tap on the desired visual image and then move it to the desired location in two-dimensional workspace 80 with a finger.

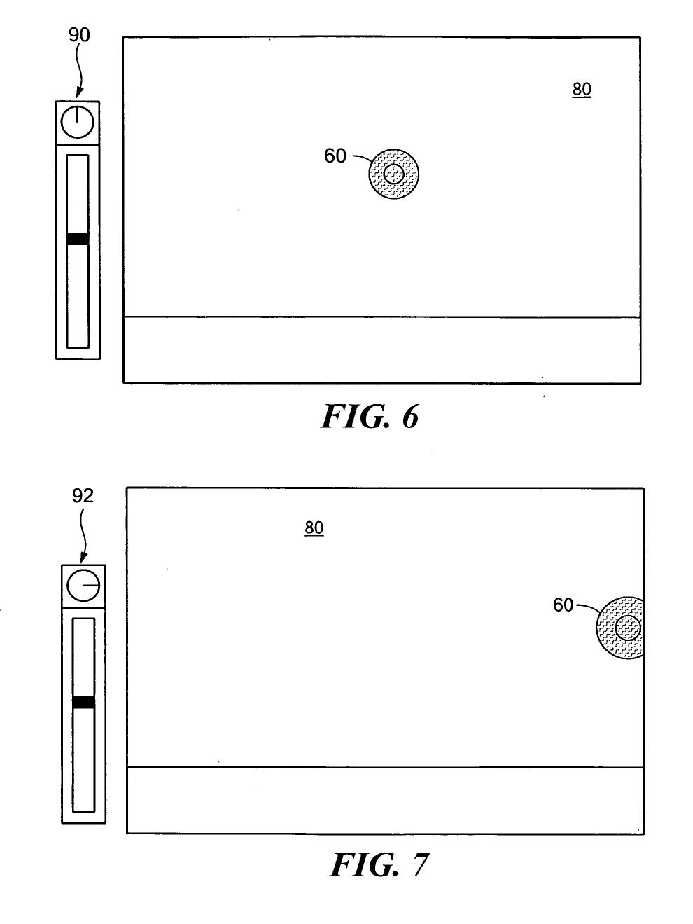

An example of positioning a visual image in the two-dimensional workspace with an input device to adjust the volume and pan in accordance with one embodiment of system 10 and the method thereof is now discussed with reference to FIGS. 6-10.

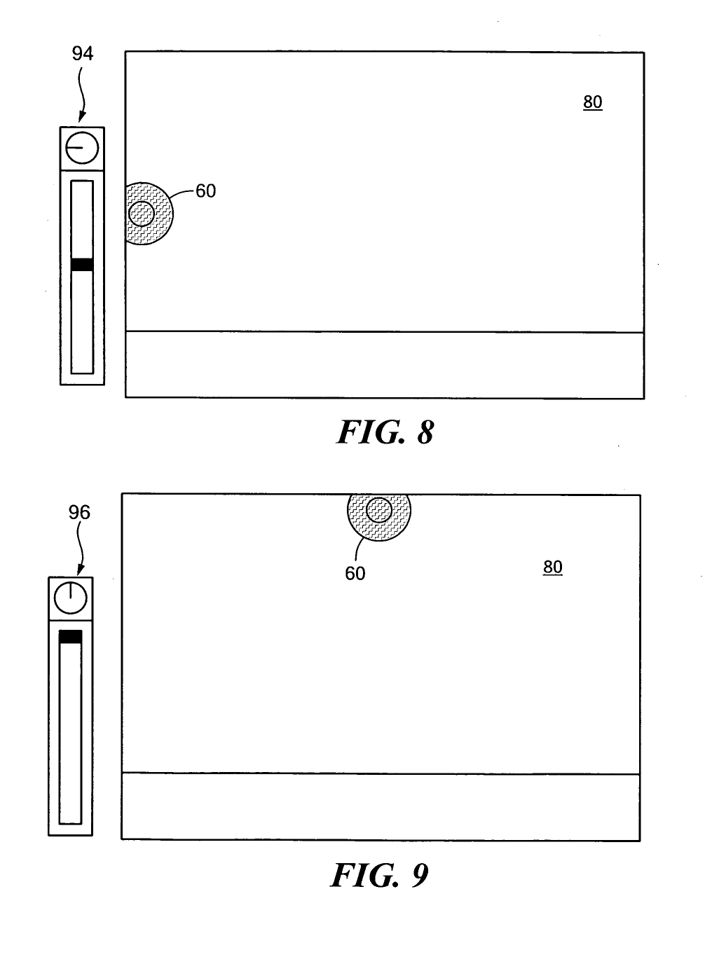

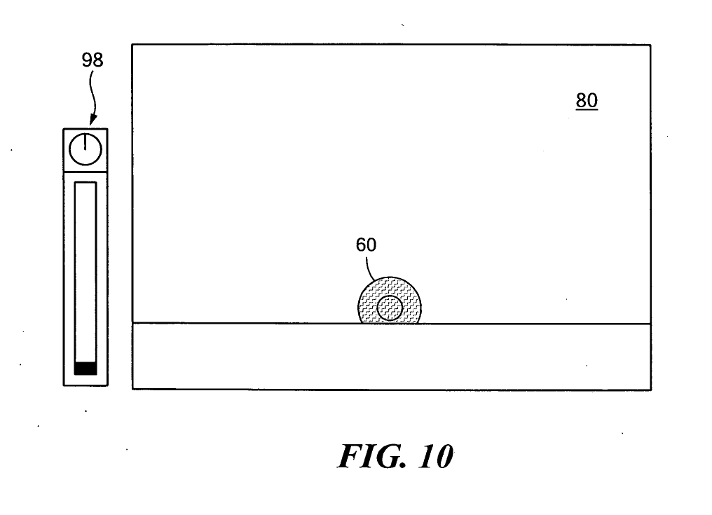

FIG. 6 shows an example in which a user has positioned a sound represented by visual image 60 in the middle of two-dimensional workspace 80 to set the volume at half and the pan position in the middle corresponding to the volume and pan of the slider and potentiometer shown at 90. FIG. 7 shows an example in which a user has positioned a sound is represented as visual image 60 in the middle and far right of two-dimensional workspace 80 to set the volume at half and the pan position to the right, corresponding to the slider and pan position indicated at 92. FIG. 8 shows an example in which a user has positioned a sound represented by visual image 60 in the middle and far left of two-dimensional workspace 80 to set the volume at half and the pan position to the left, corresponding to the slider and potentiometer indicated at 94. FIG. 9 shows an example in which a user has positioned a sound is represented by visual image 60 in the middle and top of two-dimensional workspace 80 to set to volume at full and the pan position to in the middle, corresponding to the slider and potentiometer indicated at 96. FIG. 10 shows an example in which a user has positioned a sound is represented by visual image 60 in the middle and bottom of two-dimensional workspace 80 to set the volume set at zero and the pan position in the middle, corresponding to the slider and potentiometer indicated at 98.

FIG. 5 shows one example where a user has positioned visual images 56-70 in two-dimensional workspace 80 using an input device in a similar manner as discussed above with reference to FIGS. 6-10 to create a mix which represents the visual and audio representation of each audio file and its associated channel, the user has input to system 10, as discussed above with reference to FIGS. 2 and 4. This mix corresponds to the mix indicated by mixing deck 86, FIG. 5. The result is visual audio mixing system 10 provides a visual and audio representation of the placement of the various audio files and their respective channels. This provides a visual feedback to the user as to the position of the audio files for each of the channels with respect to each other. System 10 is easy to use and less expensive than conventional mixing systems. System 10 is also intuitive to use and may provide instant visual feedback to the user, rather than having to learn how the controls of a mixing deck function. Thus, the user can see what visual effect corresponds to what audio effect.

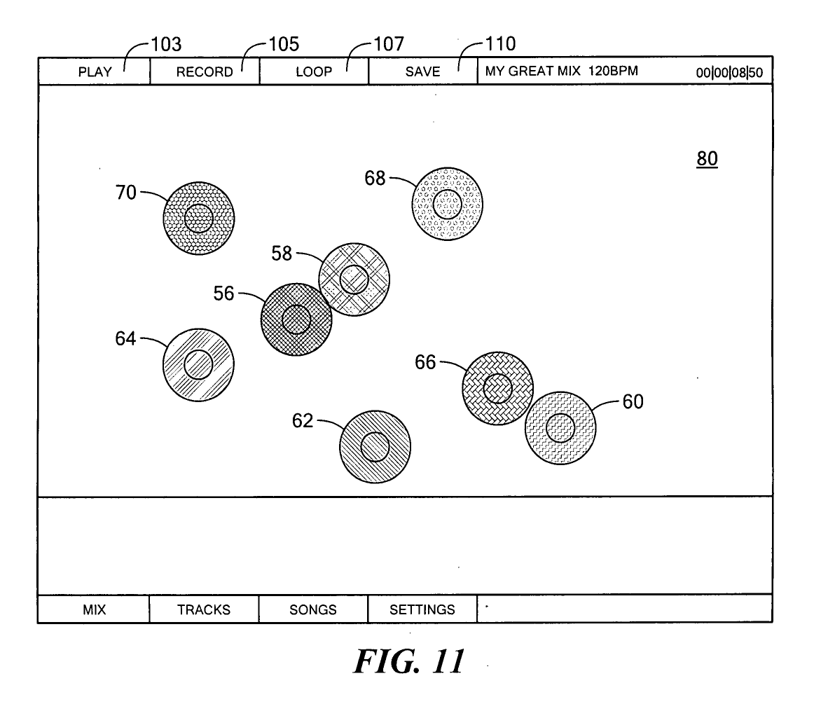

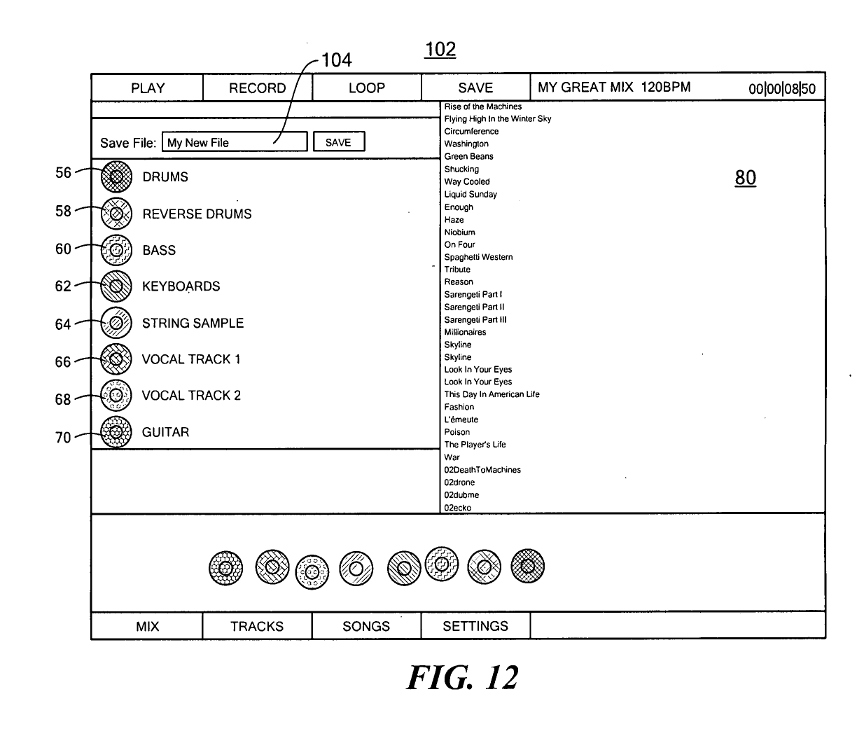

Once the desired mix is complete, the user may click save control button 100, FIG. 11, to save the mix. FIG. 12 shows one example of screen 102 wherein the user has provided a file name for the mix to be saved in box 104. Audio output engine 110, FIG. 1, then creates and saves the output audio file(s) 112 which may then be input to audio engine 12 as input audio file(s) 114. In one embodiment, audio output engine 110 may output a composite file representing the audio and visual mix of the visual images. The output audio files 112 and/or the output composite files may also be sent to marketplace 24, as shown at 113, to allow the files to be exchanged by users 26 in marketplace 24. Marketplace 24 allows anyone with music talent to upload their audio files to be shared by other users using system 10. The audio files can then be input into audio input engine 12, as discussed above. In one example, marketplace 24 may be a fee-based exchange system.

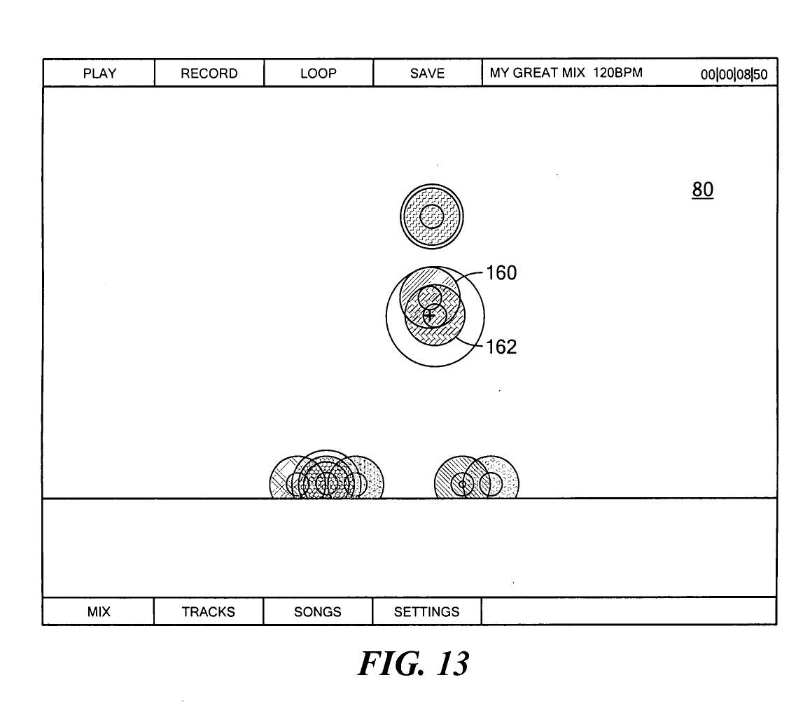

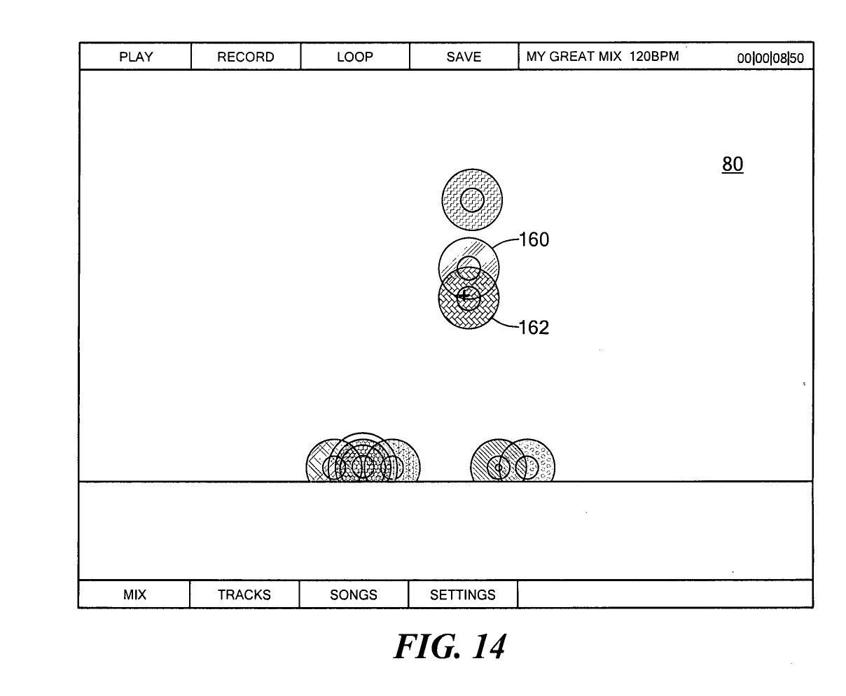

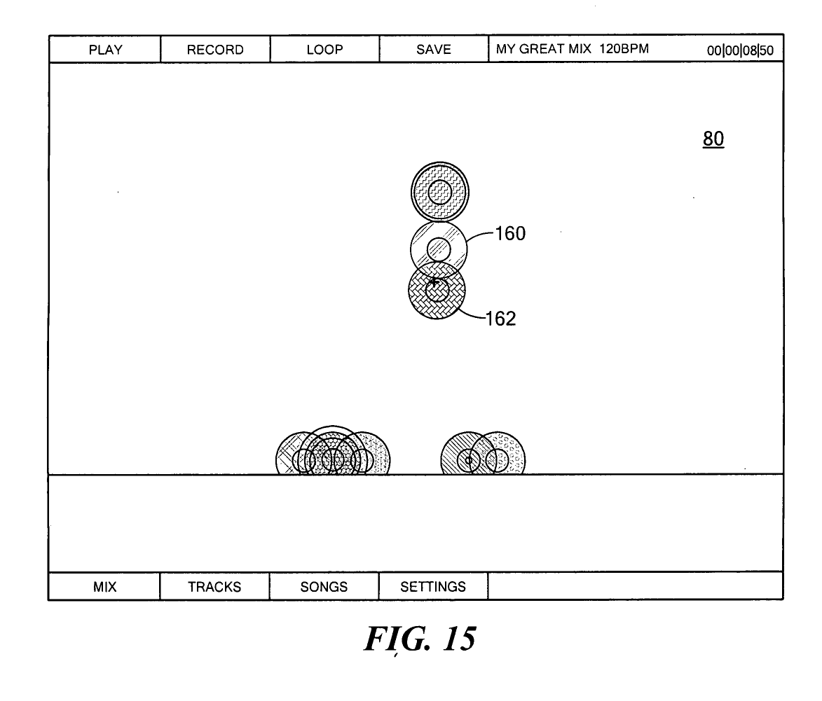

System 10 may also include physics engine 150 which is responsive to coordinate engine 79. Physics engine 150 is preferably configured to simulate behavior of visual images which have been instantiated in two-dimensional workspace 80. In one example, physics engine 150 includes collision detect engine 152 which is configured to prevent two or more visual images instantiated in the two-dimensional workspace from occupying the same position at the same time. If a user attempts to position two visual images at the same position and at the same time in two-dimensional workspace, collision detect engine 152 will cause the two visual images to repel each other. For example, FIG. 13 shows one example in which a user has attempted to put visual images 160 and 162 at the same location and at the same time in two-dimensional workspace 80. Collision detect engine 152, FIG. 1, prevents this and causes visual images 160 and 162 to repel away from each other as shown in FIGS. 14 and 15. This is a significant improvement over the conventional mixing systems discussed in the Background section above.

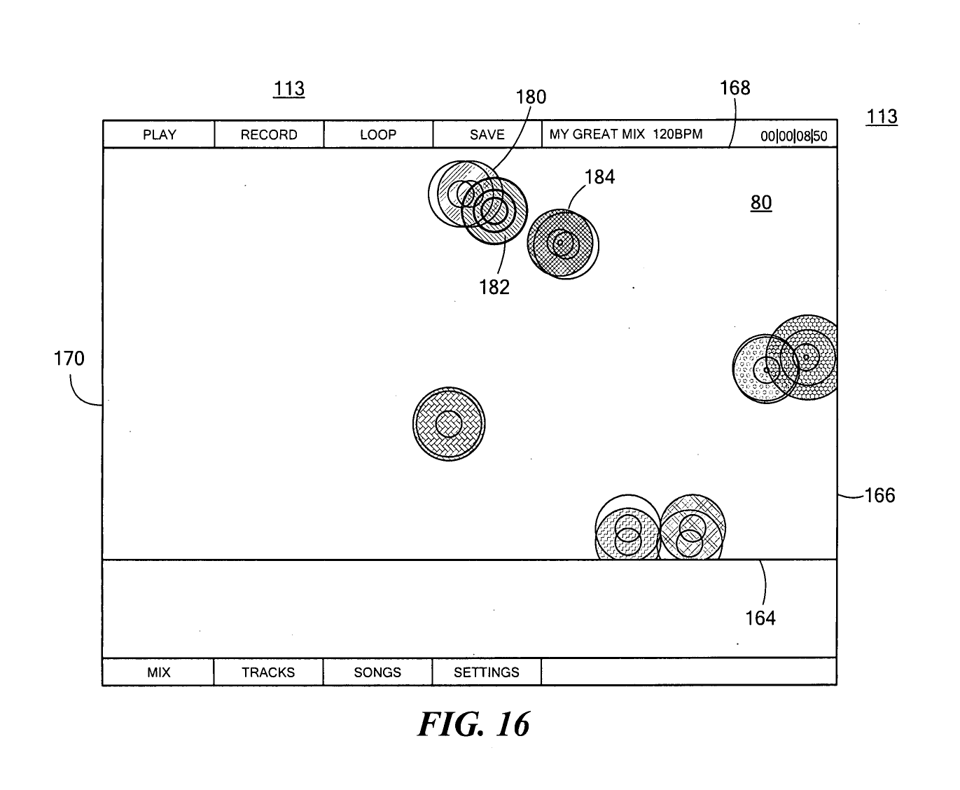

In one embodiment, physics engine 150, FIG. 1, is configured to define four walls in two-dimensional workspace 80, e.g., walls 164, 166, 168, and 170, FIG. 16.

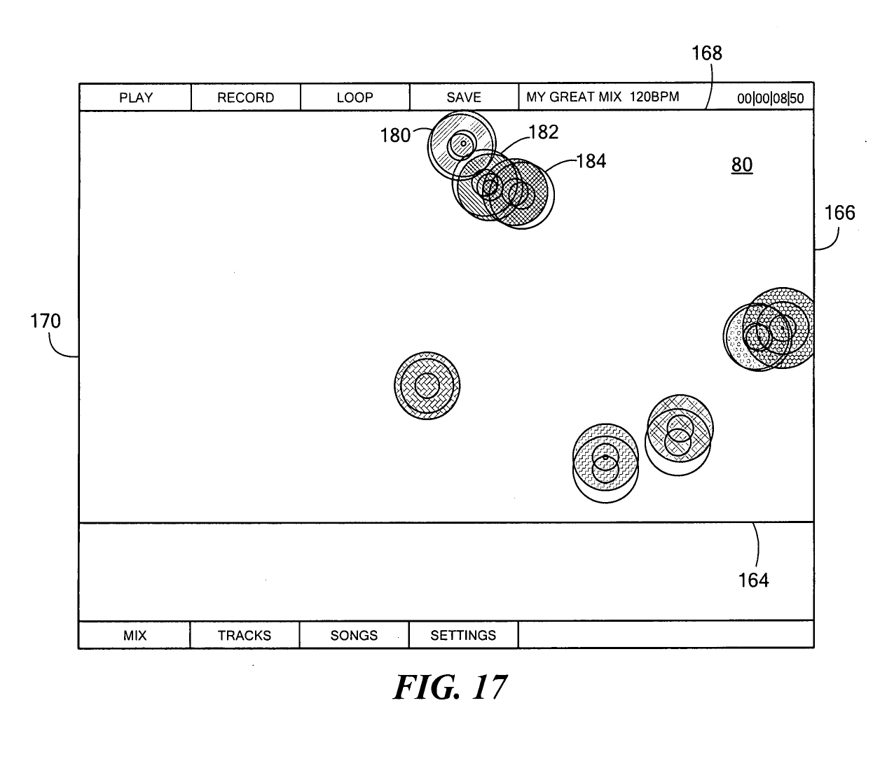

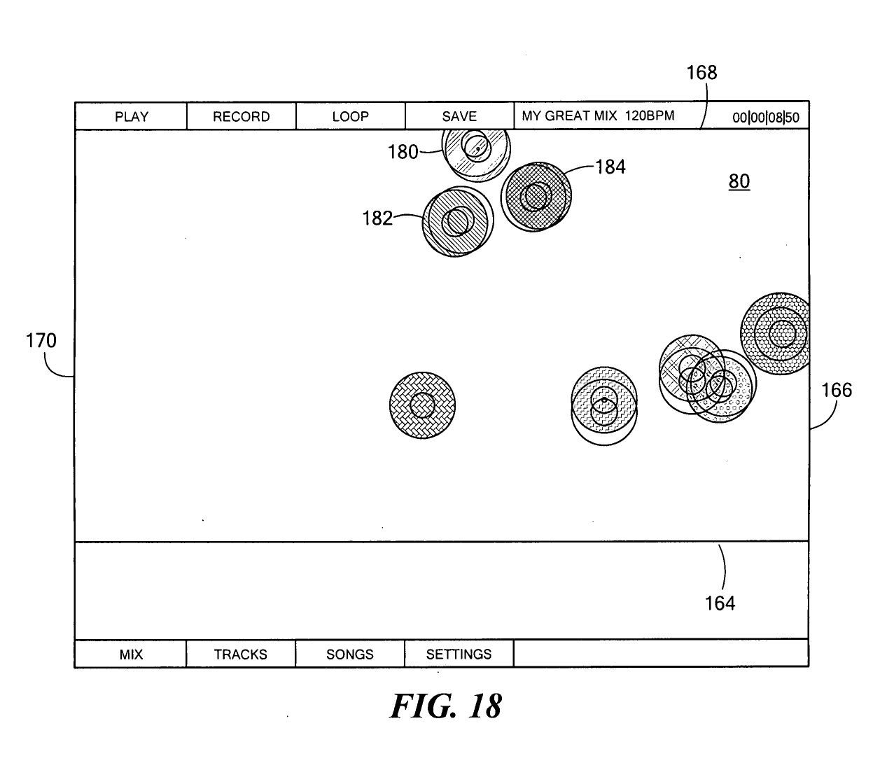

Physics engine 150, FIG. 1, preferably includes movement engine 170 which is responsive to user defined movement of an input of device, e.g., tilting an accelerometer on a device having input screen 113, FIG. 16, such as an iPhone®, iPad®, or similar type device, in one or more predetermined directions which causes the visual images which have been instantiated in two-dimensional workspace 80 to bounce off one of four walls 164-170. This causes the sounds associated with the visual images to shift slightly over time. For example, when a user tilts the input device in the direction of wall 180, movement engine 170 causes visual images 180, 182, and 184 to collide with wall 168 and bounce therefrom, as shown in FIGS. 17 and 18. This causes the sounds associated with visual images 180-184 to shift slightly over time.

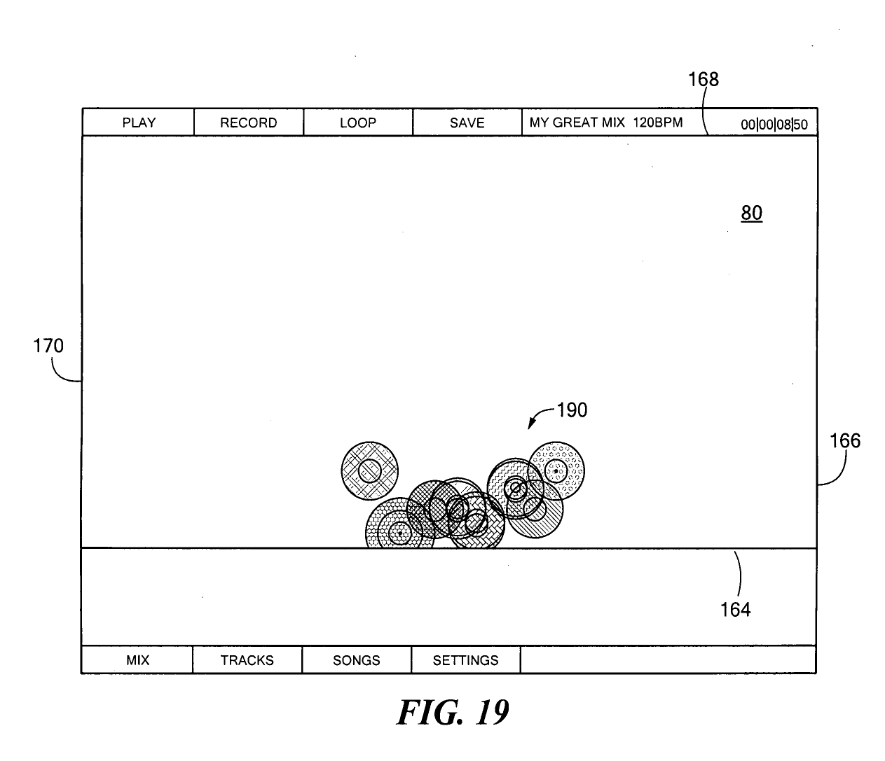

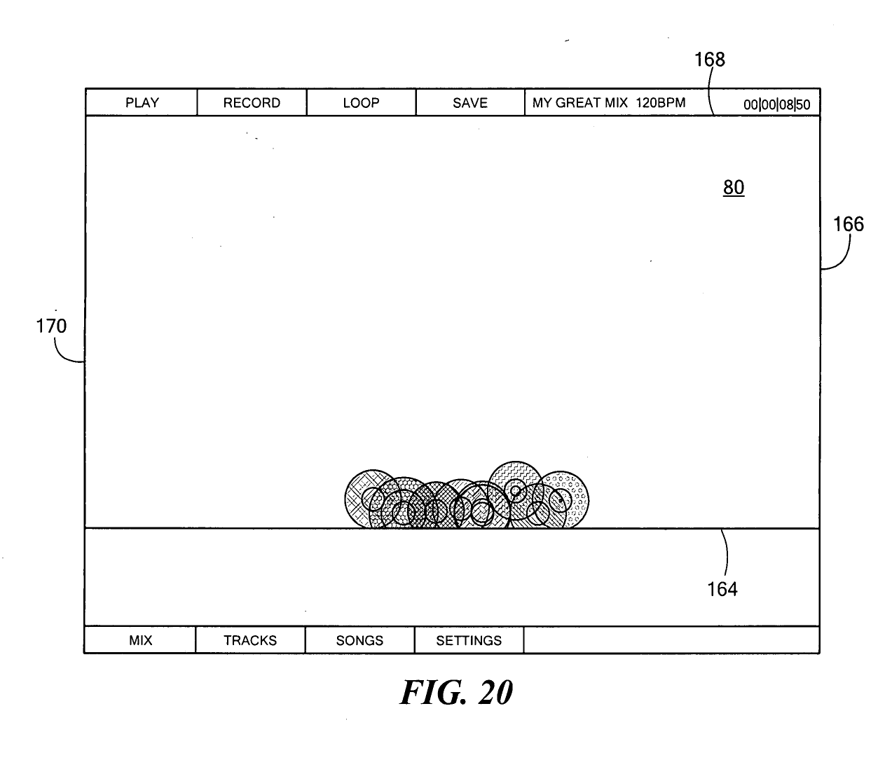

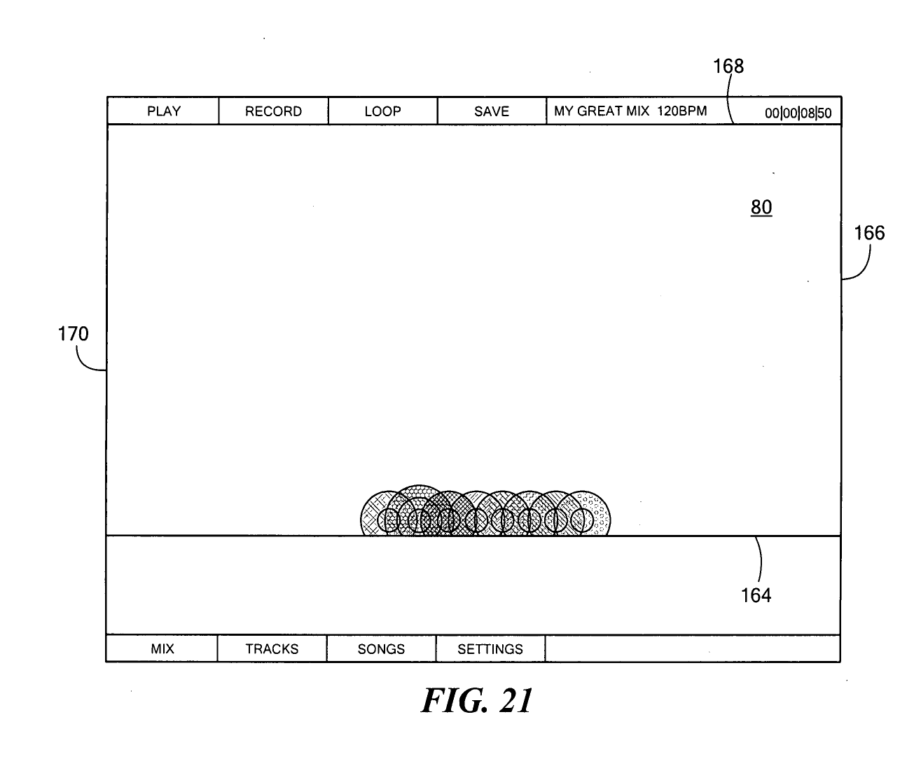

In another example, physics engine 150, FIG. 1, includes acceleration level engine 177 which is responsive to user defined movement of the input device in one or more predetermined directions, as discussed above. Acceleration level engine 177 is configured to move the visual images instantiated in two-dimensional workspace 80 to move toward one of walls 164-170 in response to user movement of the input device to simulate gravity. FIG. 19 shows an example where the user has tilted the input device such that wall 164 is lower than walls 166-170. In response therto, acceleration level engine 177 has simulated gravity by moving visual images 190 toward wall 164, as shown in FIGS. 20 and 21.

Shape select engine 72, FIG. 1, may also be configured to add a desired effect to visual images instantiated in the two-dimensional workspace by a user. Shape select engine 72 preferably changes the appearance of the visual images in the two-dimensional workspace 80 based on the desired effect. The desired effect on the visual images instantiated in workspace 80 may include reverberation, delay, a low pass filter, or any other desired effect known to those skilled in the art. The change in appearance of the visual images in two-dimensional workspace 80 may include softening of the visual image to represent a desired effect, adding moving concentric rings to represent the desired effect, shading of the visual image to represent the desired effect, or any similar type change of appearance of the visual images.

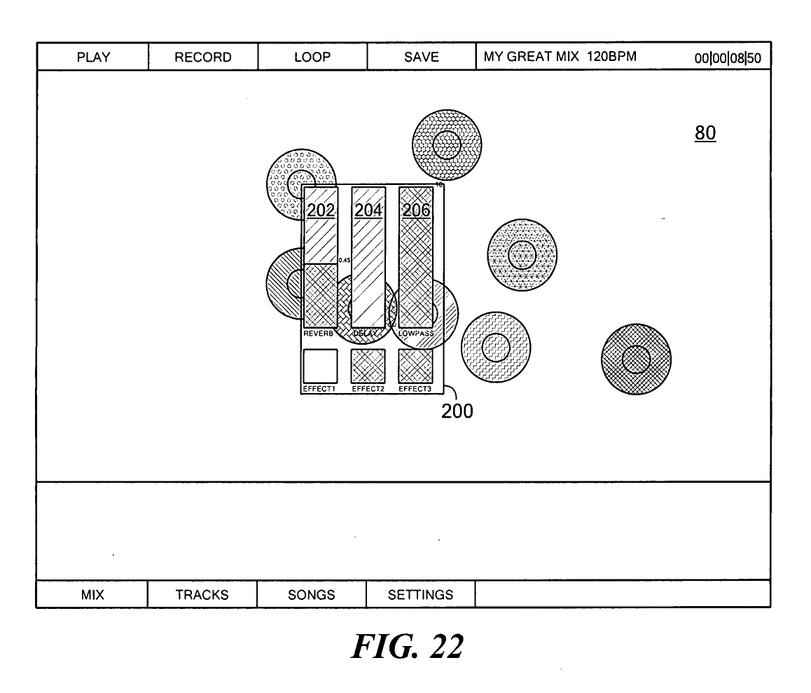

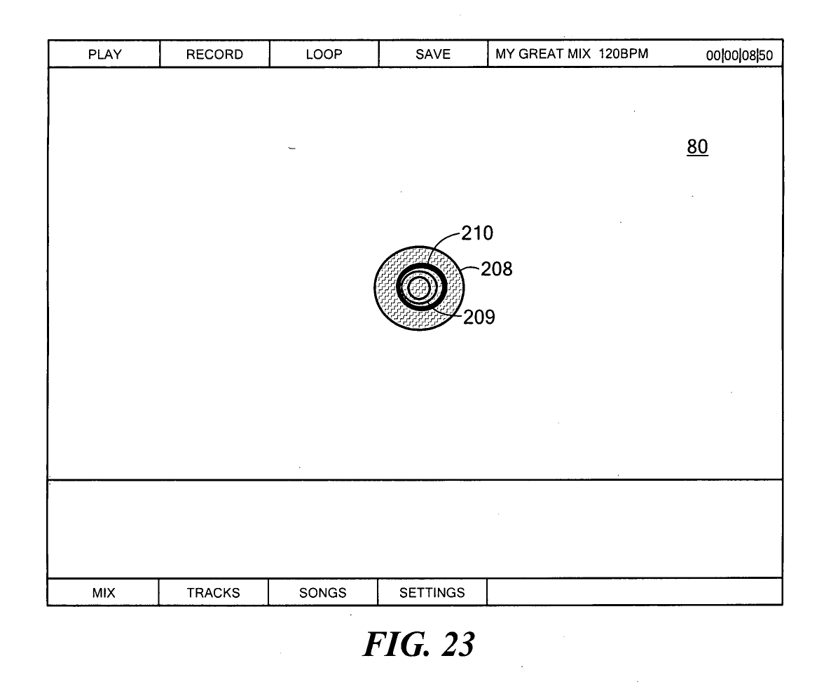

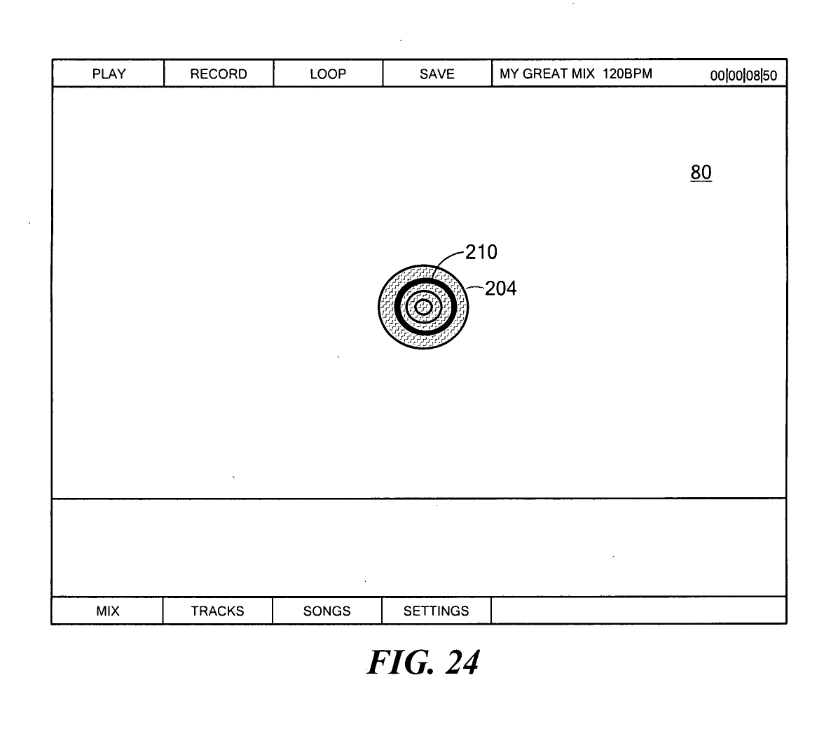

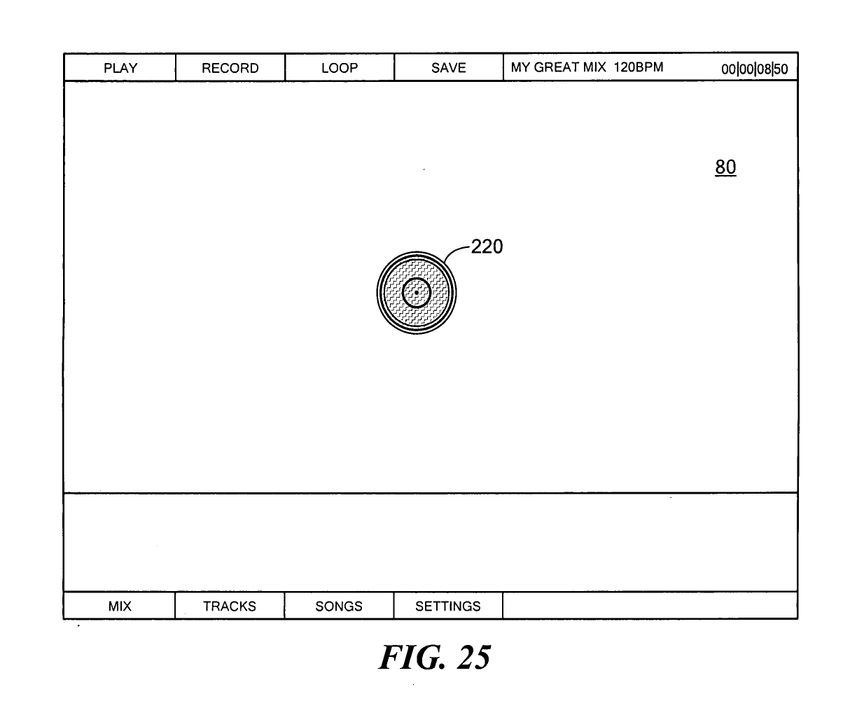

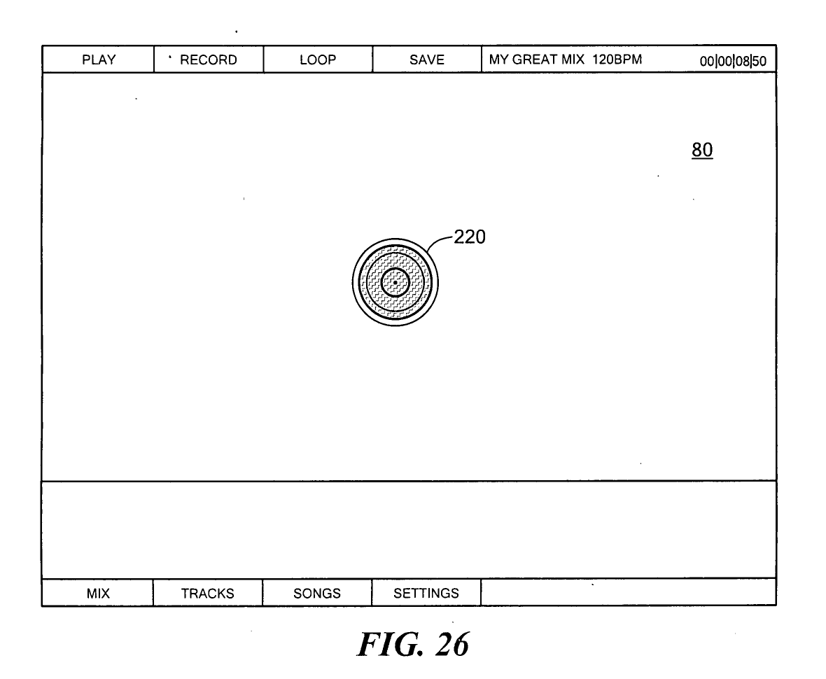

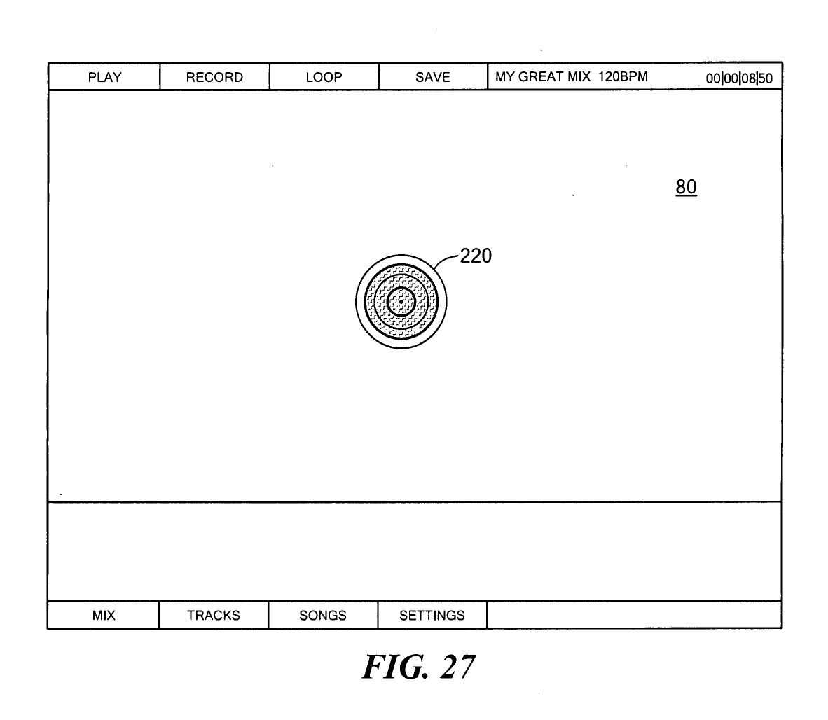

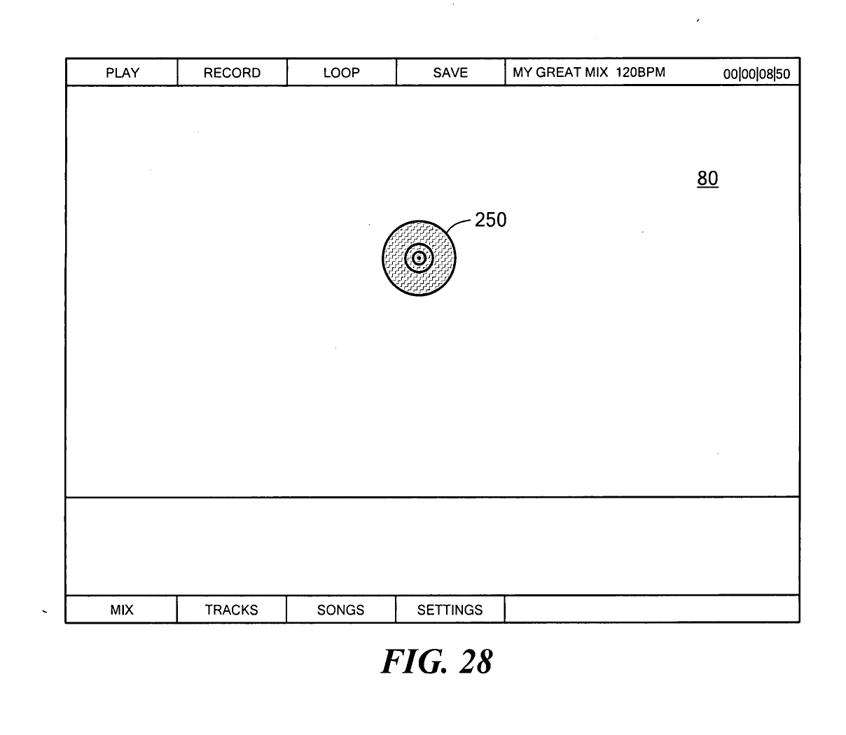

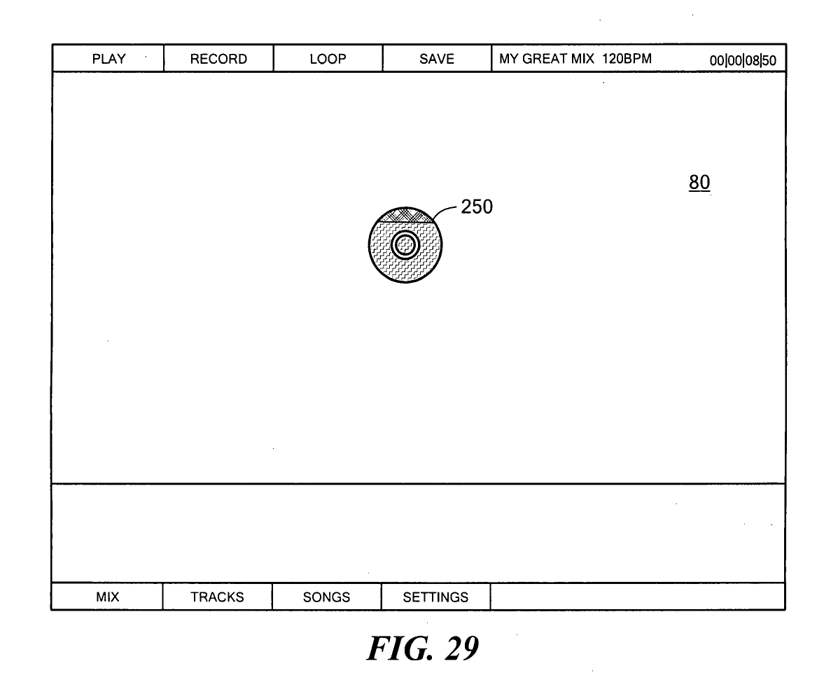

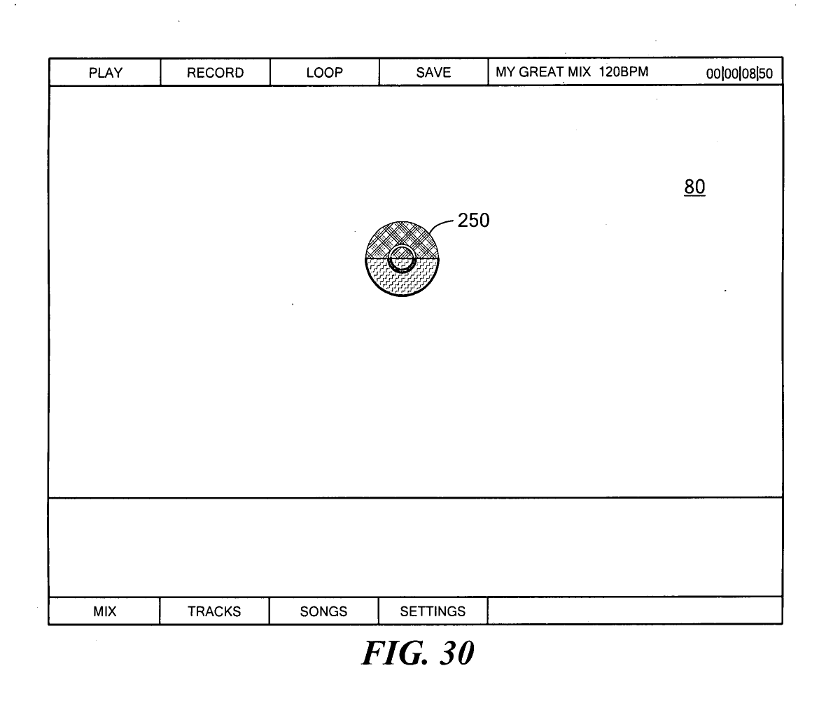

For example, after a user has double-clicked on a desired visual image in two-dimensional workspace 80, FIG. 22, system 10 displays window 200. Multiple effects can be set for the visual images instantiated in two-dimensional workspace 80 with slider controls, e.g., slider control 202 for reverb, slider control 204, for delay, and slider control 206 to simulate the effect of a low pass filter. For example, a user can set the delay for a visual image instantiated in two-dimensional workspace 80 by positioning delay slider 202 to produce a desired effect. FIGS. 23 and 24 shows one example of a delay effect produced on visual image 208 wherein concentric ring 210 extends outward from visual image 209 to represent the delay effect. In another example, reverb slider 202, FIG. 22, may be used to create a visual representation of a reverb effect on a visual image instantiated in two-dimensional workspace 80. In this example, the reverb effect on the visual image 220, FIG. 25, is a softening of visual image 220 as further shown in FIGS. 26-27. In yet another example, low pass slider 206, FIG. 22, may be used to simulate a low pass filter effect of one or more of the visual images instantiated in two-dimensional workspace 80. In this example, the low pass filter effect has been created for visual image 250, FIG. 28. The darkening of visual image 250 shows the effect of a low pass filter as shown in FIGS. 29-30.

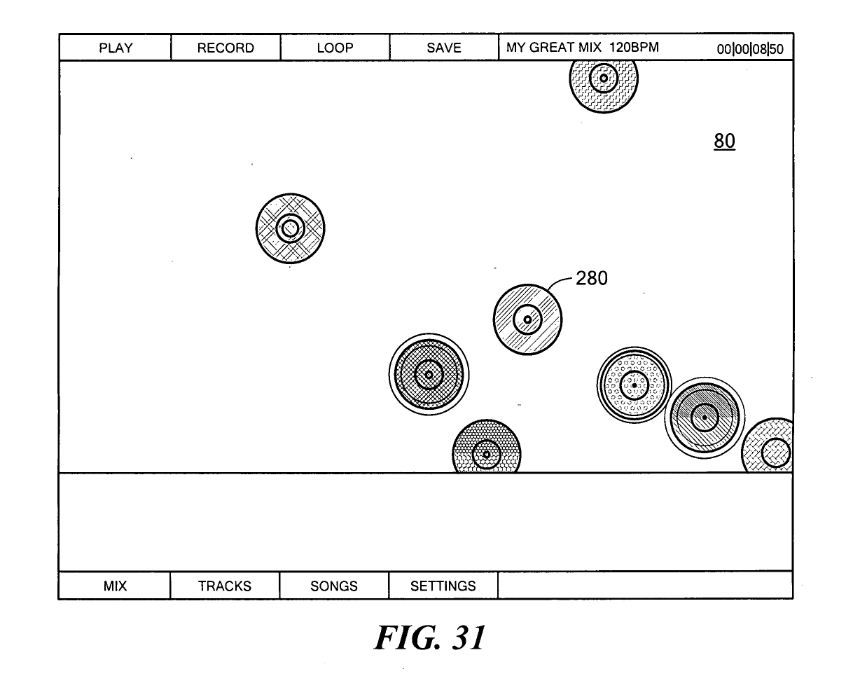

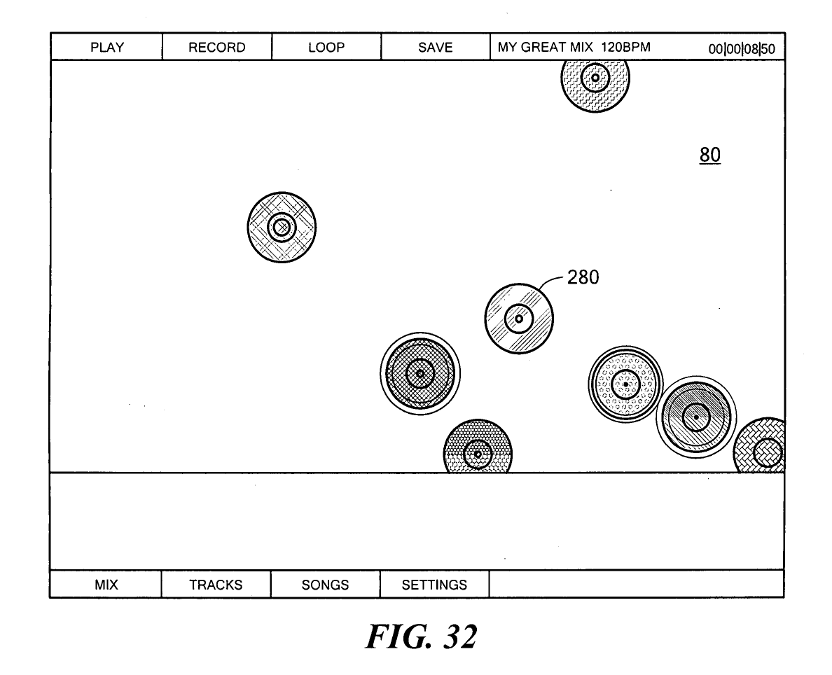

In one example, one of the visual images instantiated in two-dimensional workspace 88 may be selected such that it is the only visual image which will emit sound and the other visual images in two-dimensional workspace 80 will be muted. For example, as shown in FIG. 31, as user may double-tap or click on visual image 280 in two-dimensional workspace 80. This causes only visual image 280 to emit sound and the other visual images instantiated workspace 80 will be muted and darkened, as shown in FIG. 32.

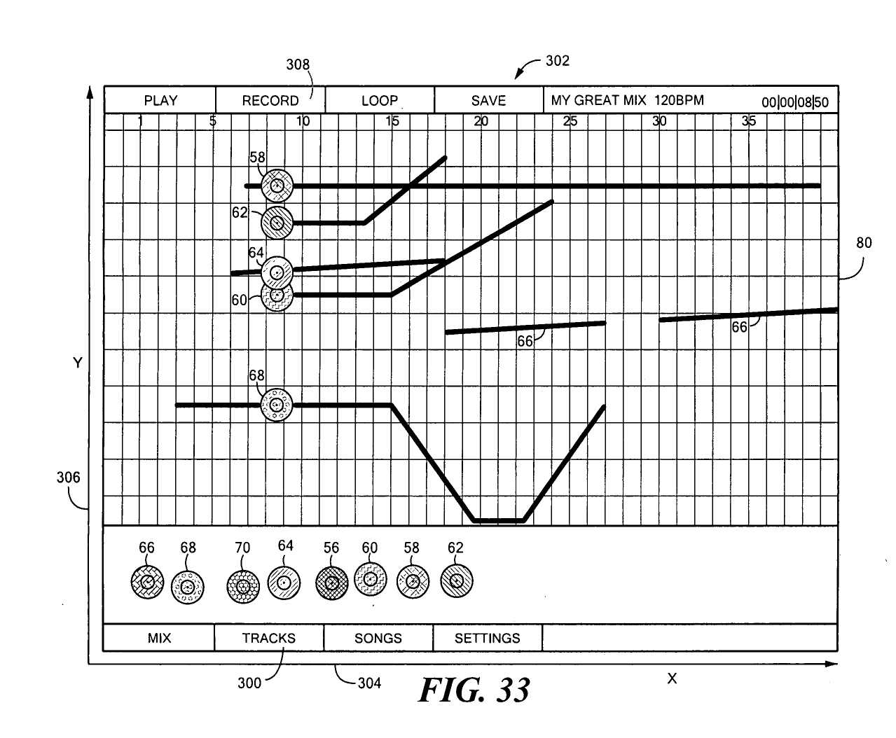

In one embodiment, system 10 and the method thereof may allow a user to manipulate the visual images in two-dimensional workspace over time. In this example, when a user clicks tracks button 300, FIG. 4, screen 302, FIG. 33 will be generated by system 10. This provides a “sideways” view of the mix view in order to show volume over time of one or more of the visual images instantiated in the two-dimensional workspace. In this example, X-axis 304 represents time and Y-axis 306 represents volume. Pan is not represented in this view. When a user clicks record button 308, a performance “record” will record the volume data over time in any window but can be seen at least in part in this window. In this example, the lines for the tracks of visual images 58, 60, 62, 64, and 68 are shown for a particular time period and will change direction, either up or down, based on the volume. Track 66 is shown beginning at a different point in time than tracks 58, 60, 62, 64, and 68. This is a significant improvement over conventional digital audio workstations.

In addition to saving and recording the mix of the visual and audio representation of each of the audio files, system 10 also provides for playing and looping of the mix by using play control 103, FIG. 3 and loop control 107.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

What is claimed is:

1. A visual audio mixing system comprising:
an audio input engine configured to input one or more audio files each associated with a channel;
a shape engine responsive to the audio input engine configured to create a unique visual image of a definable shape and/or color for each of the one or more of audio files;
a visual display engine responsive to the shape engine configured to display each visual image;
a shape select engine responsive to the visual display engine configured to provide selection of one or more visual images;
a two-dimensional workspace;
a coordinate engine responsive to the shape select engine configured to instantiate selected visual images in the two-dimensional workspace; and
a mix engine responsive to coordinate engine configured to mix the visual images instantiated in the two-dimensional workspace such that user provided movement of one or more of the visual images in one direction represents volume and user provided movement in another direction represents pan to provide a visual and audio representation of each audio file and its associated channel.

2. The system of claim 1 further including an audio output engine configured to output one or more audio files including the audio representation of the mix.

3. The system of claim 2 in which the audio output engine is configured to output one or more composite files including the visual and audio representation of the mix.

4. The system of claim 3 in which the input audio files and/or the output audio files and/or the output composite files are stored in a marketplace.

5. The system of claim 4 in which the marketplace provides for exchanging of the input audio files and/or the output audio files and/or the output composite files by a plurality of users.

6. The system of claim 5 in which the input audio engine is configured to input the input audio files and/or the output audio files and/or the composite files from the marketplace.

7. The system of claim 1 in which the coordinate engine is responsive to an input device.

8. The system of claim 7 in which the input device include one or more of: a mouse, a touch screen, and/or tilting of an accelerometer.

9. The system of claim 8 in which the input device is configured to position the visual images instantiated in the two-dimensional workspace to adjust the volume and pan of the visual images in the two-dimensional workspace to create and/or modify the visual and audio representation of each audio file and its associated channel.

10. The system of claim 9 in which user defined movement of one of the visual images instantiated in the two-dimensional workspace by the input device in a vertical direction adjusts the volume associated with the visual image and user defined movement of the visual image by the input device in a horizontal direction adjusts the pan associated with the visual image.

11. The system of claim 1 further including a physics engine responsive to the coordinate engine configured to simulate behavior of the one or more visual images instantiated in the two-dimensional workspace.

12. The system of claim 11 in which the physics engine includes a collision detect engine configured to prevent two or more visual images instantiated in the two-dimensional workspace from occupying the same position at the same time.

13. The system of claim 12 in which the collision detect engine is configured cause the two or more visual images instantiated in the two-dimensional workspace which attempted to occupy the same location at the same time to repel each other.

14. The system of claim 11 in which the physics engine is configured to define four walls in the two-dimensional workspace.

15. The system of claim 14 in which the physics engine includes a movement engine responsive to user defined movement of the input device in one or more predetermined directions, the movement engine configured to cause selected visual images instantiated in the two-dimensional workspace to bounce off one or more of the four walls.

16. The system of claim 15 in which the bouncing of the one or more visual images off one or more of the four walls causes the sounds associated with the selected visual images to shift slightly over time.

17. The system of claim 14 in which the physics engine includes an acceleration level engine responsive to user defined movement of the input device in one or more predetermined directions configured to cause visual images instantiated in the two-dimensional workspace to be attracted to one or more of the four walls to simulate gravity.

18. The system of claim 1 in which shape select engine is configured to add a desired effect to the visual images instantiated in the two-dimensional workspace.

19. The system of claim 18 in which shape select engine is configured to change the appearance of one or more visual images instantiated in the two-dimensional workspace based on the desired effect.

20. The system of claim 19 in which the desired effect includes one or more of reverberation, delay and/or a low pass filter.

21. The system of claim 20 in the change of appearance of the one or more visual images instantiated in the two-dimensional workspace includes softening of the visual image to represent the desired effect.

22. The system of claim 20 in which the change of appearance of the one or more visual images instantiated in the two-dimensional workspace includes moving concentric rings to represent the desired effect.

23. The system of claim 20 in which the change of appearance of the one or more visual images instantiated in the two-dimensional workspace includes shading of the one or more selected visual images.

24. The system of claim 18 in which shape select engine is configured to mute all but one visual image instantiated in the two-dimensional workspace.

25. A visual audio mixing system comprising:
an audio input engine configured to input one or more audio files each associated with a channel;
a shape engine responsive to the audio input engine configured to create a unique visual image of a definable shape and/or color for each of the one or more of audio files;
a two-dimensional workspace;
a coordinate engine responsive to the shape select engine configured to instantiate selected visual images in the two-dimensional workspace; and
a mix engine responsive to coordinate engine configured to mix the visual images instantiated in the two-dimensional workspace such that user provided movement of one or more of the visual images in one direction represents volume and user provided movement in another direction represents pan to provide a visual and audio representation of each audio file and its associated channel.

26. A method of visual audio mixing, the method comprising:
inputting one or more audio files each associated with a channel;
creating a unique visual image of a definable shape and/or color for each of the one or more of audio files;
displaying each visual image;
selecting of one or more visual images;
instantiating selected visual images in a two-dimensional workspace; and
mixing the visual images instantiated in the two-dimensional workspace such that user provided movement of one or more of the visual images in one direction represents volume and user provided movement in another direction represents pan to provide a visual and audio representation of each audio file and its associated channel.

27. A method of visual audio mixing, the method comprising:
inputting one or more audio files each associated with a channel;
creating a unique visual image of a definable shape and/or color for each of the one or more of audio files;
instantiating selected visual images in a two-dimensional workspace; and
mixing the visual images instantiated in the two-dimensional workspace such that user provided movement of one or more of the visual images in one direction represents volume and user provided movement in another direction represents pan to provide a visual and audio representation of each audio file and its associated channel.
